(19) United States
(12) Patent Application Publication
(10) Pub. No.: US 2026/0095074 A1
(43) Pub. Date: Apr. 2, 2026

(54) ELECTRIC ROTATING MACHINE, AND MANUFACTURING METHOD THEREFOR

(71) Applicant: MITSUBISHI ELECTRIC MOBILITY CORPORATION, Tokyo (JP)

(72) Inventors: Manabu YOSHINORI, Tokyo (JP); Norihiro WATANABE, Tokyo (JP); Akio SHINGU, Tokyo (JP)

(73) Assignee: MITSUBISHI ELECTRIC MOBILITY CORPORATION, Tokyo (JP)

(21) Appl. No.: 19/111,849

(22) PCT Filed: Mar. 17, 2023
(86) PCT No.: PCT/JP2023/010535

§ 371 Date: Mar. 14, 2025

(51) Int. Cl. H02K 1/18; H02K 5/20; H02K 15/14; H02K 15/40

(52) U.S. Cl. CPC H02K 1/185; H02K 5/203; H02K 15/14; H02K 15/40; H02K 2213/03

(57) ABSTRACT

An frame of an electric rotating machine has a cylinder portion that fits a stator core on an inner circumferential surface thereof, a fastening flange that protrudes from an axis-direction end portion of the cylinder portion toward the axis-direction outside of the cylinder portion and is fastened to a supporting member; the fastening flange is formed in such a way as to incline toward a direction departing from the outer circumferential surface of the cylinder portion with respect to the radial direction of the cylinder portion; it is configured in such a way that in a state where the fastening flange is fastened to the supporting member, compression-direction stress is generated on a root portion, at the outer-circumferential-surface side of the cylinder portion, of the fastening flange.

### TECHNICAL FIELD

The present disclosure relates to an electric rotating machine and the manufacturing method thereof.

### BACKGROUND ART

An electric rotating machine having a frame holding a stator core therein is well known. The electric rotating machine is fixed to a supporting member through the intermediary of the foregoing frame. For example, a conventional electric rotating machine disclosed in Patent Document 1 is provided with a stator outer cylinder, as a frame, having the shape of a cylindrical tube, and is fixed to a bracket, as a supporting member, through the intermediary of the stator outer cylinder. The stator core of the electric rotating machine is fixed to the inner circumference portion of the stator outer cylinder by shrink fitting.

The stator outer cylinder in the conventional electric rotating machine disclosed in Patent Document 1 has a fastening flange, at least one of the axis-direction end portions, which protrudes from the outer circumferential surface of the stator outer cylinder to the radially outside thereof. The stator outer cylinder is preliminarily formed in such a way as to incline in a direction approaching the outer circumferential surface of the stator outer cylinder.

In the electric rotating machine disclosed in Patent Document 1, when the stator core is shrink-fitted to the inner circumference portion of the stator outer cylinder, the fastening flange of the stator outer cylinder is deformed in such a way as to be parallel to the radial direction of the stator outer cylinder so that a satisfactory fastening surface between the fastening flange and a housing is formed; thus, fastening force is secured between the stator outer cylinder and the housing.

In addition, a conventional electric rotating machine disclosed in Patent Document 2 is provided with a housing, as a frame, that holds a stator core by shrink fitting, and is fixed to a supporting member, through the intermediary of the housing. The foregoing housing has a first tab in which a first penetration hole that is penetrated by a first screw is formed and a second tab in which a second penetration hole that is penetrated by a second screw and a fitting portion that fits to a position adjustment member are provided; a first facing side, of the first tab, that faces the supporting member is formed more apart from the supporting member than a second facing side, of the second tab, that faces the supporting member is.

In the electric rotating machine disclosed in Patent Document 2, because the first facing side of the first tab in the foregoing housing is formed more apart from the supporting member than the second facing side of the second tab is, the second facing side of the second tab can be made substantially parallel to the supporting member; thus, the accuracy of positioning the housing to the supporting member can be raised.

### PRIOR ART REFERENCE

### Patent Document

[Patent Document 1] Japanese Patent No. 5607591
[Patent Document 2] Japanese Patent No. 6731112

### DISCLOSURE OF THE INVENTION

### Problems to be Solved by the Invention

In the case of the conventional electric rotating machine disclosed in Patent Document 1, when fastening of the stator outer cylinder to the stator core is not appropriate, the fastening flange remains inclined and satisfactory fastening force between the stator outer cylinder and the housing may not be formed. In addition, there has been a possibility that when the inclined fastening flange is forcibly deformed by bolt fastening, tensile stress generated in the bending portion at the root of the fastening flange breaks the fastening flange, hence the stator outer cylinder, as a frame, that holds the stator core is damaged.

In addition, in the conventional electric rotating machine disclosed in Patent Document 2, there has been a possibility that because being forcibly deformed by screw fastening, the first tab is broken by tensile-component stress generated in the root portion thereof, hence the housing, as a frame, that holds the stator core is damaged.

The present disclosure has been made to disclose a technology for solving the above problem, and an objective thereof is to provide a high-reliability electric rotating machine that realizes prevention of damage on a frame that holds a stator core.

In addition, the present disclosure has been made to disclose a technology for solving the above problem, and an objective thereof is to provide a manufacturing method a high-reliability electric rotating machine that realizes prevention of damage on a frame that holds a stator core.

### Means for Solving the Problems

An electric rotating machine disclosed in the present disclosure includes
a stator core formed annularly,
a cylindrical tubular frame whose inner circumferential surface is fitted on the stator core and that holds the stator core,
a rotor that is disposed in an inner space of the stator core and whose outer circumferential surface faces an inner circumferential surface of the stator core through an air gap, and
a rotor shaft that is fixed to and pivotably supported by the rotor; the frame has a cylinder portion that fits the stator core into the inner circumferential surface, and a fastening flange that is provided at an axis-direction end portion of the cylinder portion, protrudes from the axis-direction end portion toward the radially outside of the cylinder portion, and is fastened to a supporting member that supports the electric rotating machine; the fastening flange is formed in such a way as to incline toward a direction departing from the outer circumferential surface of the cylinder portion with respect to the radial direction of the cylinder portion, and it is configured in such a way that in a state where the fastening flange is fastened to the supporting member, compression-direction stress is generated on a root portion, at the outer circumferential surface side of the cylinder portion, of the fastening flange.

Moreover, a manufacturing method for the electric rotating machine disclosed in the present disclosure is characterized in that the inner circumferential surface of the frame is formed through cutting machining, and in that a machining-receiving surface at a time of the cutting machining is a portion, of the fastening flange, that is located more inside in the radial direction than the circumference of a pitch circle that passes through a radial-direction most-inner-circumferential point of a boss that is provided on the supporting member and receives the fastening flange.

Moreover, a manufacturing method for the electric rotating machine, disclosed in the present disclosure, that has a water jacket that is fitted on the outer circumferential surface of the cylinder portion of the frame so as to form a cooling passage therein and is welded to the frame so that the cooling passage is sealed; the is characterized method in that the outer circumferential surface of the cylinder portion of the frame that is fitted into the water jacket is formed through press working, and in that the inner circumferential surface of the cylinder portion of the frame that is fitted on the stator core is formed through cutting machining.

Moreover, a manufacturing method for the electric rotating machine, disclosed in the present disclosure, that has a water jacket that is fitted on the outer circumferential surface of the cylinder portion of the frame so as to form a cooling passage therein and is welded to the frame so that the cooling passage is sealed; the method is characterized by including
a first process in which the water jacket is fitted on the frame,
a second process in which the frame and the water jacket are welded to each other for sealing at an anti-fastening-flange side of the cylinder portion of the frame, and
a third process in which the frame and the water jacket are welded to each other for sealing at the fastening flange side of the cylinder portion of the frame, and in that the second process is performed before the third process is performed.

Furthermore, a manufacturing method for the electric rotating machine, disclosed in the present disclosure, that has a water jacket that is fitted on the outer circumferential surface of the cylinder portion of the frame so as to form a cooling passage therein and is welded to the frame so that the cooling passage is sealed; the method is characterized by including
a first process in which the water jacket is fitted on the frame,
a second process in which the frame and the water jacket are welded to each other for sealing,
a third process in which cutting machining is applied to the inner circumferential surface of the cylinder portion of the frame, and
a fourth process in which the stator core is fitted on the inner circumferential surface of the cylinder portion of the frame, and in that the first process, the second process, the third process, and the fourth process are performed in that order.

### Advantage of the Invention

The present disclosure makes it possible to obtain a high-reliability electric rotating machine that realizes prevention of damage on a frame that holds a stator core.

The manufacturing method disclosed in the present disclosure makes it possible to obtain a high-reliability electric rotating machine that realizes prevention of damage on a frame that holds a stator core.

### BRIEF DESCRIPTION OF THE DRAWINGS

FIG. 1 is a schematic cross-sectional view of a rotating electric machine according to Embodiment 1;

FIG. 2 is an explanatory view of a frame in the electric rotating machine according to Embodiment 1;

FIG. 3 is a schematic cross-sectional view of a rotating electric machine according to Embodiment 2;

FIG. 4 is an explanatory view for explaining deformation of a fastening flange in the electric rotating machine according to each of Embodiments 1 and 2;

FIG. 5 is an explanatory view for explaining the relationship between each of the dimensions of the frame and the dimension of a water jacket in the electric rotating machine according to Embodiment 2; and

FIG. 6 is an explanatory view of the fastening flange of the frame in the electric rotating machine according to each of Embodiments 1 and 2.

### MODE FOR CARRYING OUT THE INVENTION

### Embodiment 1

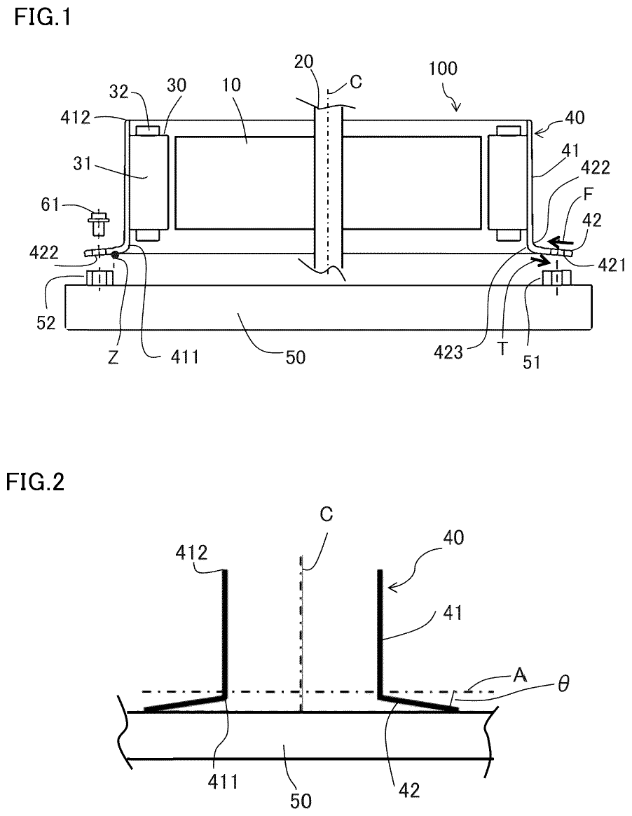

FIG. 1 is a schematic cross-sectional view of a rotating electric machine according to Embodiment 1. In FIG. 1, an electric rotating machine 100 has a rotor 10, a rotor shaft 20, and a stator 30. The rotor 10 has a rotor core and magnetic-field poles that are formed of two or more permanent magnets and embedded in the rotor core, and is fixed to the rotor shaft 20. Through the intermediary of a bearing, the rotor shaft 20 is pivotably supported by a housing (unillustrated) that holds the electric rotating machine 100.

The stator 30 has a stator core 31 in which two or more division cores are annularly aligned, a stator coil 32 attached to the stator core 31, and a cylindrical tubular frame 40. The rotor 10 is inserted into the inner space of the stator 30; the outer circumferential surface of the rotor core faces the inner circumferential surface of the stator core 31 through a predetermined air gap. The stator core 31 is fitted into the inner circumferential surface of the frame 40; the frame 40 holds the stator core 31.

The stator coil 32 is, for example, a star-connected three-phase coil; the stator coil 32 is supplied with three-phase electric power by an electric-power conversion apparatus (unillustrated) formed of two or more semiconductor switching devices and generates a rotating magnetic field. Due to interaction between the rotating magnetic field generated by the stator 30 and the magnetic-field poles formed of the permanent magnets provided in the rotor 10, the rotor 10 rotates while generating torque so as to drive a load such as a vehicle.

The frame 40 has a cylinder portion 41, into the inner circumferential surface of which the stator core 31 is fitted, and a fastening flange 42 provided at one axis-direction end portion 411 of the cylinder portion 41. The other axis-direction end portion 412 of the cylinder portion 41 is an open end. The fastening flange 42 protrudes from the one axis-direction end portion 411 of the cylinder portion 41 toward the radially outside of the cylinder portion 41 and is formed annularly.

Two or more bolt holes 421 that are each penetrated by bolts 61 are provided in a fastening flange 42 provided in the frame 40. FIG. 1 illustrates the case where two bolt holes 421 are provided at the respective positions that face each other through the center axis C of the frame 40; however, another arrangement may be allowed. In addition, as may be necessary, the bolt holes 421 are provided apart from each other at two or more positions in a fastening flange.

Through the intermediary of the fastening flange 42 of the frame 40, two or more bolts 61 (in FIG. 1, only one bolt 61 is illustrated) that penetrate the respective bolt holes 421 fix the stator 30 held by the frame 40 to the supporting member 50 provided in the housing, through the intermediary of bosses 52.

FIG. 2 is an explanatory view of a frame in the electric rotating machine according to Embodiment 1 and illustrates the frame 40 in FIG. 1 through a schematic drawing. As illustrated in FIG. 2, the fastening flange 42 protrudes from the one axis-direction end portion 411 in the cylinder portion 41 of the frame 40 toward the radially outside of the cylinder portion 41 and is formed in such a way as to incline with an inclination angle θ in a direction departing from the outer circumferential surface of the cylinder portion 41 with respect to a virtual straight line A perpendicular to the center axis C of the cylinder portion 41.

In FIGS. 1 and 2, as described above, the fastening flange 42 inclines in a direction departing from the outer circumferential surface of the cylinder portion 41; however, the fastening flange 42 abuts on a mounting surface, which is the top surface of the boss 52 fixed to the supporting member 50, and then is fastened to the supporting member 50 by the bolt 61, so that the fastening flange 42 is fixed to the supporting member 50 while being deformed in such a way as to be parallel to the mounting surface of the boss 52. Because the mounting surface, which is the top surface of the boss 52, is formed in such a way as to be parallel to the plane of the supporting member 50, the fastening flange 42 is fixed to the supporting member 50 while being deformed in such a way as to be parallel to the plane, which is the mounting surface of the supporting member 50.

Because, as mentioned above, the fastening flange 42 is fastened and fixed by the bolt 61 to the supporting member 50, the inclination angle θ of the fastening flange 42 becomes substantially 0 [°]. As a result, as illustrated in FIG. 1, compression-direction stress, indicated by an arrow F, is generated in the outer-circumferential-surface side of a root portion 422 of the fastening flange 42. Therefore, the fastening flange 42 can be prevented from being broken by tensile-direction stress T to the root portion 422.

Because the curvature, caused by bending, of the outer-circumferential-surface-side root portion 422 of the fastening flange 42 is smaller than the curvature, caused by bending, of the inner-circumferential-surface-side root portion 423, the stress concentration factor at outer-circumferential-surface-side root portion 422 becomes larger than the stress concentration factor at the inner-circumferential-surface-side root portion 423.

Because the inner-circumferential-surface-side root portion 423 whose stress concentration factor is smaller than that of the outer-circumferential-surface-side root portion 422 is set to the portion to which tensile-direction stress indicated by T is applied, the tensile-direction stress T, which is a cause of breakage of the fastening flange 42, becomes smaller than a compression-direction stress F; thus, the fastening flange 42 is prevented from being broken. Accordingly, because the curvature, caused by bending, of the outer-circumferential-surface-side root portion 422 can be made small, the layout performance of the electric rotating machine 100 can be raised.

### Embodiment 2

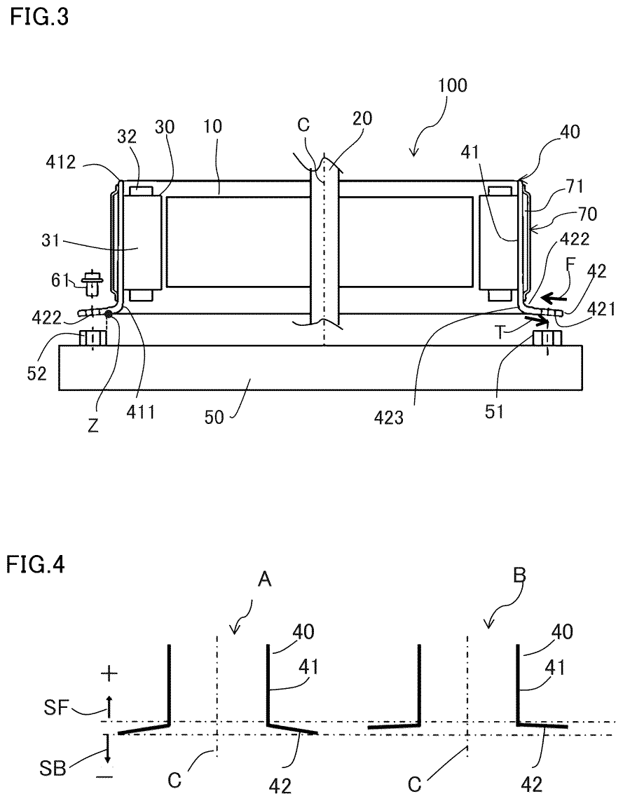

Next, an electric rotating machine according to Embodiment 2 will be explained. FIG. 3 is a schematic cross-sectional view of a rotating electric machine according to Embodiment 2; the constituent elements the same as or similar to those of the electric rotating machine according to Embodiment 1, illustrated in FIG. 1, are designated by reference characters the same as those therein. In FIG. 3, the electric rotating machine 100 has a ring-shaped water jacket 70 that is fitted into the outer circumferential surface of the cylinder portion 41 of the frame 40. The other configurations are the same as those of the electric rotating machine according to foregoing Embodiment 1.

Because the water jacket 70 is welded to the outer circumferential surface of the cylinder portion 41 at a position close to the one axis-direction end portion 411, which is the fastening-flange-side end portion of the cylinder portion 41 of the frame 40, one side portion of an internal cooling passage 71 is sealed; and because the water jacket 70 is welded to the outer circumferential surface of the cylinder portion 41 at a position close to the other axis-direction end portion 412, which is the anti-fastening-flange-side end portion of the cylinder portion 41 of the frame 40, the other side portion of the internal cooling passage 71 is sealed. The stator core 31 of the electric rotating machine 100 is cooled by coolant water that passes through the cooling passage 71 in the water jacket 70.

The water jacket 70 is fitted on the frame 40 by press-fitting or shrink-fitting and then is welded to the cylinder portion 41 of the frame 40, as described above, so that the cooling passage 71 is formed; due to press-fitting of the water jacket 70 on the cylinder portion 41 of the frame 40 and welding of the water jacket 70 to the cylinder portion 41 of the frame 40, the fastening flange 42 that has been formed in such a way as to incline in the direction departing from the outer circumferential surface of the cylinder portion 41 is deformed toward the outer-circumferential-surface side of the cylinder portion 41 of the frame 40. As a result, the inclination angle θ, indicated in FIG. 2, of the fastening flange 42 becomes smaller than the original value.

In other words, when the water jacket 70 is press-fitted on the outer circumferential surface of the cylinder portion 41 of the frame 40, the cylinder portion 41 of the frame 40 is deformed toward to the radial-direction inside, so that the fastening flange 42 is deformed toward the outer-circumferential-surface side of the cylinder portion 41. In addition, at a time of welding between the water jacket 70 and the cylinder portion 41, the one axis-direction end portion 411 and the other axis-direction end portion 412 of the cylinder portion 41 are heated to expand; then, when being cooled, they contract. In contrast, the outer circumferential surface other than the one axis-direction end portion 411 and the other axis-direction end portion 412 of the cylinder portion 41 are not heated by the foregoing welding; thus, deformation thereof is restrained. As a result, deformation in the direction inclining toward the outer-circumferential-surface side of the cylinder portion 41 is generated in the fastening flange 42.

However, because the fastening flange 42 is formed in such a way as to incline in the direction departing from the outer circumferential surface cylinder portion 41, assembly variation caused by the foregoing press-fitting and welding can be absorbed; thus, the inclination of the fastening flange to the direction departing from the outer circumferential surface of the cylinder portion 41 can be maintained. Accordingly, as described in Embodiment 1, the outer-circumferential-surface-side root portion 422 of the fastening flange 42 can be prevented from being broken by fastening to the supporting member 50.

FIG. 4 is an explanatory view for explaining deformation of a fastening flange in the electric rotating machine according to each of Embodiments 1 and 2; the original state of the frame 40 is indicated by “A”, and the state where the water jacket 70 has been press-fitted on the frame 40 and then the foregoing welding has been performed is indicated by “B”.

The inclination amount of the fastening flange 42 due to deformation of the frame 40 is affected by setting of the fitting fastening interference δ between the frame 40 and the water jacket 70, the welding condition, the fastening interference between the frame 40 and the stator core 31, and the like. In this situation, when supposing that in FIG. 4, the inclination, indicated by an arrow SF, toward the outer-circumferential-surface side of the cylinder portion 41 is “+” direction and the inclination, indicated by an arrow SB, toward the direction departing from the outer circumferential surface f the cylinder portion 41 is direction, the fitting fastening interference δ between the frame 40 and the water jacket 70 is set to “0” [mm] to “0.5” [mm], the inclination angle θ of the fastening flange 42, caused by press-fitting of the water jacket 70 on the cylinder portion 41 of the frame 40, and the inclination angle θ of the fastening flange 42, caused by the foregoing welding, become approximately “+0” [°] to “+0.25” [‘] and “+0” [°] to “+0.5” [°], respectively.

Accordingly, when the inclination angle θ of the fastening flange 42 in the original state where the press-fitting and the welding of the water jacket 70 have not been performed is set to “−1” [’], the inclination toward the direction departing from the outer circumferential surface of the cylinder portion 41 can be maintained, even in the state where the press-fitting and the welding of the water jacket 70 have been performed.

Because the deformation of the frame 40, caused by fitting of the stator core 31, is caused by deformation of the cylinder portion 41 of the frame 40 toward the radially outside of the frame 40, the fastening flange 42 inclines toward the anti-outer-circumferential-surface side of the cylinder portion 41, i.e., toward the direction departing from the outer circumferential surface of the cylinder portion 41; thus, the deformation of the frame 40, caused by fitting of the stator core 31 can cancel or restrain the effect of the deformation caused by press-fitting and welding of the water jacket 70.

It is preferable that the inclination angle θ of the fastening flange 42 is the same as or smaller than “1” [°] with respect to the radial direction perpendicular to the center axis C of the cylinder portion 41. When the inclination angle θ exceeds “1” [′], the stress in the fastening flange 42 generated after the fastening flange 42 is fastened to the supporting member 50 by the bolt 61 exceeds the material strength of the frame 40. In this situation, the frame 40 is formed of, for example, SPHC (Steel Plate Hot Commercial: hot-rolled steel sheet) or SPCC (Steel Plate Cold Commercial: cold-rolled steel sheet).

When, as described above, the inclination angle θ of the fastening flange 42 is the same as or smaller than “1” [°] with respect to the radial direction perpendicular to the center axis C of the cylinder portion 41, each of compression stress F generated to the outer-circumferential-surface-side root portion 422 of the fastening flange 42 and tensile stress T generated to the inner-circumferential-surface-side root portion 423 can be restrained to be the same as or smaller than the material strength of the frame 40.

The dimension of the plate-thickness of the water jacket 70 is set to be smaller than that of the frame 40. Because the frame 40 needs to be fitted on the stator core 31, high rigidity and high dimensional accuracy thereof are required; however, because the frame 40 is formed so as to fulfill the requirements, the water jacket 70 can be assembled therewith without hindrance by being fitted thereon and welded thereto. Thus, deformation of the frame 40 can be restrained.

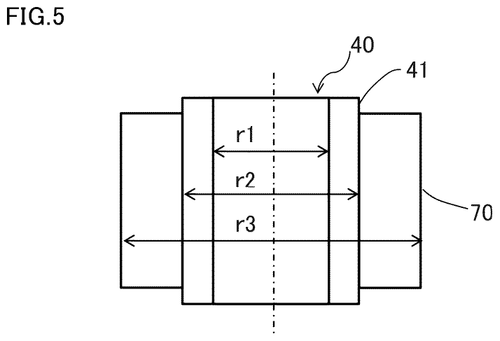

Next, a method of setting the relationship between the press-fitting interference that brings a desirable shape for the water jacket 70 and the diameter of the frame 40 after the water jacket 70 has been fitted on the frame 40 will be explained in detail. FIG. 5 is an explanatory view for explaining the relationship between each of the dimensions of the frame and the dimension of the water jacket in the electric rotating machine according to Embodiment 2.

As illustrated in FIG. 5, the inner diameter of the frame 40, the outer diameter of the frame 40 after the water jacket 70 has been fitted on the frame 40, and the outer diameter of the water jacket 70 are set to r1 [mm], r2 [mm], and r3 [mm], respectively (the expression of each of the units of r1, r2, and r3 will be omitted). In addition, the fitting fastening interference is set to δ; the respective Young's moduli of the frame 40 and the water jacket 70 whose constituent materials are one and the same are set to E.

The contact pressure P at a time when the water jacket 70 is press-fitted on the outer circumferential surface of the frame 40 is given by the equation (1) below.

$$P = E \times δ ( r {3}^{2} - r {2}^{2} ) ( r {2}^{2} - r {1}^{2} ) / 2 r {2}^{3} ( r {3}^{2} - r {1}^{2} ) \qquad ( 1 )$$

The stress σ generated in the water jacket 70 is given by the equation (2) below.

$$σ = P \times p 2 / 2 ( r 3 - r 2 ) \qquad ( 2 )$$

The foregoing equations (1) and (2) suggest that as each of the inner diameter r1 of the cylinder portion 41, the outer diameter r2 of the frame 40 after the water jacket 70 has been fitted on the frame 40, and the outer diameter r3 of the water jacket 70 becomes smaller, the contact pressure P becomes larger and then the stress σ becomes larger; thus, the material strength becomes more unfavorable. Accordingly, it is desirable that the setting is performed in such a way that as the outer diameter r2 of the frame 40 after press-fitting of the water jacket 70 is smaller, the generated stress σ is more restrained and also in such a way that as the outer diameter r2 of the frame 40 after press-fitting of the water jacket 70 is smaller, the fitting fastening interference δ becomes smaller.

That is to say, the relationship between “the fitting fastening interference δ” and each of “the inner diameter r1 of the frame 40 after fitting of the water jacket 70, the outer diameter r2 of the frame 40 after fitting of the water jacket 70, and the outer diameter r3 of the water jacket 70” is a positive correlation; thus, in a range limited to some extent, the foregoing correlation can almost be approximated by a linear correlation.

Accordingly, the relationship between the fitting fastening interference δ and the outer diameter D (=r2) of the frame 40 after fitting between the frame 40 and the water jacket 70 is expressed by the equation (3) below by use of a coefficient α; then, the equation (3) can be utilized as a target when the fitting fastening interference δ and the outer diameter D (=r2) of the frame 40 after fitting are set.

$$α \times δ = D \qquad ( 3 )$$

The inventors have decided to estimate the coefficient α in the equation (3) in the following manner. At first, it has been assumed that SPHC is utilized for the water jacket 70 and the range of the plate-thickness dimension thereof is set to “1.0” [mm] to “3.5” [mm], and then it has been decided that the tensile strength is set so as not to exceed “270” [MPa], which is the tensile-strength limit value of a typical SP (Steel Plate) material.

Thus, when by use of the foregoing equation (1) regarding to the contact pressure P at a time of press-fitting, we studied the condition that σ becomes the same as or smaller than 270 MPa, the contact pressure P became maximum when the dimension of the plate-thickness of the water jacket 70 has been set to “1.0” [mm] that is the lower limit of the assumed range; furthermore in that situation, we selected “0.3” [mm], “0.4” [mm], and “0.5” [mm], as the representative values of the fitting fastening interference δ, from the range of “0” [mm] to “0.5” [mm] so as to roughly calculate the outer diameter D (=r2) of the frame 40, after fitting between the frame 40 and the water jacket 70, that fulfills the condition that the stress σ generated in each of the fitting fastening interferences δ is the same as or smaller than 270 MPa.

After the foregoing rough calculation, we confirmed that when the fitting fastening interference δ is “0.3” [mm], the outer diameter D (=r2) of the frame 40 is “190” [mm], that when the fitting fastening interference δ is “0.4” [mm], the outer diameter D (=r2) of the frame 40 is “250” [mm], and that when the fitting fastening interference δ is “0.5” [mm], the outer diameter D (=r2) of the frame 40 is “320” [mm].

When bases on the results of the foregoing rough calculation, the fitting fastening interference δ and the outer diameter D of the frame 40 are set and the setting range of the coefficient α is calculated from the respective representative values with which the contact pressures P at a time when the water jacket 70 is fitted on the outer circumferential surface of the frame 40 become approximately maximum, it can roughly be calculated that from [α=D/δ], the desirable range of the coefficient α is from “633.3” to “640”.

Summarizing the foregoing calculation results, it is made possible that when with regard to the outer diameter D (=r2) of the frame 40 after fitting between the frame 40 and the water jacket 70, the fitting fastening interference δ, and the coefficient α, the fitting fastening interference δ and the outer diameter D (=r2) of the frame 40 after fitting between the frame 40 and the water jacket 70 are set in such a way that the coefficient α fulfills the relationship of [α×8=D] in the range from “633.3” to “640”, the relationship between the water jacket 70 and the frame 40, that is desirable in terms of the strength, can be set.

As described above, t is made possible to restrain the stress σ generated by fitting to be the same as or smaller than the tensile strength “270” [MPa] of the SP material utilized for the water jacket 70; thus, the water jacket 70 can have the strength that prevents breakage thereof.

In addition, from strength requirements, it is desirable to adopt SPHC in which a lineup with plate-thickness dimension the same as or larger than “4.0” [mm] exists, and furthermore, because the strength requirement for the water jacket 70 is not high in comparison with that for the frame 40, and hence it is not required to enlarge the plate thickness, SPCC is adopted in general; thus, the dimension of the plate thickness is selected from the range from “1.0” [mm] to “3.5” [mm] in such a way that the foregoing relational equation is established, so that the dimension of the plate thickness is made smaller than that of the frame 40 for which strength is required. Accordingly, the water jacket 70 can be attached to the frame 40 in such a way as to follow the shape of the frame 40. Therefore, deformation of the frame 40 can be made minimum.

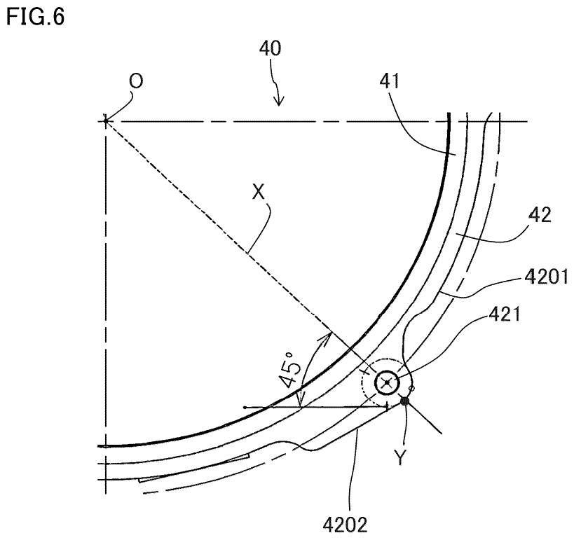

FIG. 6 is an explanatory view of the fastening flange of the frame in the electric rotating machine according to each of Embodiments 1 and 2. In FIG. 6, when X denotes a virtual straight line that connects the center O of the frame 40 with the bolt hole 421 and Y denotes the intersection point of an outer-circumference edge 4201 of the fastening 2 with the virtual straight line X, at least one outer-edge portion 4202 that passes through the intersection point Y and is connected, at an angle larger than “45” [′], with the flange circumference arc or the circumferential straight line whose center is the bolt hole 421 exists in the all circumferential edge of the ring-shaped fastening flange 42.

In the case where the angle of the outer-edge portion 4202 is smaller than “45” [°] with respect to the virtual straight line X, the absolute value of the deformation amount (warp amount) of the fastening flange 42 at a time when the water jacket 70 is welded to the frame 40 or the frame 40 is press-fitted on the stator 30 becomes large; therefore, in order to prevent the above, the outer-edge portion 4202 is made to be connected therewith at an angle the same as or larger than “45” [°] with respect to the virtual straight line X. Accordingly, because it is made possible to widen the fastening flange 42 and hence enlarge the rigidity of the fastening flange 42, the absolute value of the foregoing deformation amount (warp amount) of the fastening flange 42 can be made small; thus, the deformation amount (warp amount) of the fastening flange 42 can readily be controlled.

It may be allowed that the fastening flange 42 is formed of two or more flange parts provided apart from each other via a space. The flange parts are provided with respective bolt holes 421. In this case, the flange parts are produced through a pressing process that can adjust the inclination angles thereof individually. In some cases, due to an in-vehicle layout, it is difficult to provide fastening fixation portions evenly and at equal intervals over all the circumference of the fastening flange. In the case where two or more flange parts as the fastening fixation portions are unevenly provided, the respective deformation amounts of the flange parts become uneven after press molding or fitting of the water jacket 70; however, because the inclination angle of each of the flange parts can individually be adjusted, breakage of the frame can be prevented.

The outer circumferential surface, of the cylinder portion 41 of the frame 40, that is fitted into the water jacket 70 is formed through press working; the inner circumferential surface, of the cylinder portion 41 of the frame 40, that is fitted on the stator core 31 is finished through cutting machining. Because the outer circumferential side of the cylinder portion 41 of the frame 40 is fitted into the water jacket 70 and the inner circumferential surface of the cylinder portion 41 is fitted on the stator core 31, it is required that the outer circumferential surface and the inner circumferential surface of the frame 40 are accurately formed; however, because there exists no dimensional interference of press molding, it is selected that the inner circumferential surface of the cylinder portion 41 is finished through cutting machining.

Because high dimensional accuracy is required for the inner circumferential surface of the cylinder portion 41 of the frame 40, cutting machining is appropriate. Because dimensional accuracy as high as that required for the inner circumferential surface of the cylinder portion 41 is not required for the outer circumferential surface thereof, press working can be adopted; thus, production costs can be decreased. Moreover, the dimensional accuracy of press working is inferior to that of machining; however, because the water jacket 70 whose rigidity is smaller than that of the frame 40 follows the shape of the frame 40, it is made possible that the dimensional-accuracy inferiority of the outer circumferential surface of the frame 40 is covered and that the sealing performance for the cooling passage 71 of the water jacket 70 and the cost performance thereof are balanced with each other.

Still moreover, because the inner circumferential surface, of the frame 40, that is fitted on the stator core 31 having high rigidity is the side where the frame 40 follows the shape of the stator core 31, deformation occurs in the frame 40 when the accuracy of the inner circumferential surface is not high; however, as described above, the inner circumferential surface is formed by use of cutting machining, the inner circumferential surface of the frame 40 is formed with high dimensional accuracy; thus, even when the stator core 31 is fitted thereon, deformation of the frame 40 can be minimized.

In the configuration according to Embodiment 2 in which after the water jacket 70 is fitted on the frame 40, the fitting portion of the water jacket 70 at the fastening flange 42 side, i.e., at the one axis-direction end portion 411 side of the cylinder portion 41 and the fitting portion of the water jacket 70 at the other axis-direction end portion 412 side of the cylinder portion 41 are welded for sealing, the assembly process is performed in the order in which at first, the fitting portion of the water jacket 70 at the other axis-direction end portion 412 side of the cylinder portion 41, i.e., the fitting portion of the water jacket 70 at the anti-fastening-flange side of the cylinder portion 41 is welded, and then the fitting portion of the water jacket 70 at the one axis-direction end portion 411 side of the cylinder portion 41, i.e., the fitting portion of the water jacket 70 at the fastening flange 42 side is welded.

The manufacturing method for the electric rotating machine according to Embodiment 2 includes a first process in which the water jacket 70 is fitted on the frame 40, a second process in which the frame 40 and the water jacket 70 are welded to each other for sealing at the anti-fastening-flange side of the cylinder portion 41 of the frame 40, and a third process in which the frame 40 and the water jacket 70 are welded to each other for sealing at the fastening flange side of the cylinder portion 41 of the frame 40; the second process is performed before the third process is performed.

In the cross section of the frame 40, the one axis-direction end portion 411 of the cylinder portion 41 and the fastening flange 42 are connected with each other in an L-shaped manner; it is dynamically evident that when pressure toward the radially inside is applied to the one axis-direction end portion 411 of the cylinder portion 41, the fastening flange 42 tends to be deformed in such a way as to incline toward the outer-circumferential-surface side of the cylinder portion 41, and when, in contrast, pressure toward the radially outside of the frame 40 is applied to the other axis-direction end portion 412 of the cylinder portion 41, the fastening flange 42 tends to be deformed in such a way as to incline toward a direction departing from the outer circumferential surface of the cylinder portion 41. In the case of the electric rotating machine according to Embodiment 2, it is required that out of the foregoing deformations of the fastening flange 42, the final deformation is the latter deformation, i.e., the deformation in which the fastening flange 42 departs from the outer circumferential surface of the cylinder portion 41.

In the welding between the water jacket 70 and the frame 40, when the fitting portion of the water jacket 70 at the fastening flange 42 side of the cylinder portion 41 of the frame 40 is welded, heating by the welding enlarges the outer diameter of the cylinder portion 41 at the fastening flange 42 side; thus, the other axis-direction end portion 412 of the cylinder portion 41 is deformed toward the radially inside. As a result, the fastening flange 42 inclines toward the outer circumferential surface of the cylinder portion 41.

In contrast, when the water jacket 70 is welded at the other axis-direction end portion 412 side of the cylinder portion 41, i.e., at the anti-fastening-flange side, the outer diameter of the other axis-direction end portion 412 of the cylinder portion 41 expands; hence, the fastening flange 42 inclines toward the opposite side of the outer circumferential surface of the cylinder portion 41, i.e., toward the direction departing from the outer circumferential surface of the cylinder portion 41.

Accordingly, although the water jacket 70 is welded firstly at any one of the one axis-direction end portion 411 side and the other axis-direction end portion 412 side of the cylinder portion 41, the fastening flange 42 cannot be restrained from being deformed in such a way as to incline toward the outer circumferential surface of the cylinder portion 41; however, when the water jacket 70 at the anti-fastening-flange side of the cylinder portion 41 is firstly welded, the welding process can be proceeded under the condition that the fastening flange 42 is warped toward the opposite side of the outer circumferential surface of the cylinder portion 41; thus, the amount itself of the deformation of the cylinder portion 41 toward the outer-circumferential-surface side can be decreased.

When inner circumferential surface of the cylinder portion 41 of the frame 40 is formed by cutting machining, the machining-receiving surface in the fastening portion, of the fastening flange 42, that has the bolt hole 421 is the surface, of the fastening flange 42, more radially inside than the surface on the pitch circle, of the boss 52 that is integrated with or fixed to the supporting member 50 illustrated in each of FIGS. 1 and 3, that passes through a point Z radially most inside of the cylinder portion 41.

Two or more bosses 52 are provided in correspondence to the two or more bolt holes 421 provided spaced apart from each other in the circumferential direction of the fastening flange 42. The point Z, at the radially most inside of the cylinder portion 41, the that corresponds to each of the two or more bossed 52 is t starting point of the bent portion of the fastening flange 42 or the periphery of the starting point; moreover, the foregoing point Z is a measurement point for the flatness of the flat surface portion of the fastening flange 42. Therefore, the point Z that corresponds to each of the bosses 52 is also the reference portion (the portion abutting on a bending machine) for forming the fastening flange 42 in the frame 40; thus, when the surface, of the fastening flange 42, more radially inside than the surface on the pitch circle, of the boss 52 that is integrated with or fixed to the supporting member 50, that passes through the point Z radially most inside of the cylinder portion 41 is adopted as the machining-receiving surface, the accuracy of cutting work for the inner circumferential surface of the cylinder portion 41 and the accuracy of the assembling work can be raised.

When the radially outside of the fastening flange 42 is adopted as the receiving surface, the receiving surface is far from the center line C of the frame 40; thus, because force acts on the receiving surface when being cut, and hence the receiving surface is liable to be affected by moment, anxiety of deformation of the frame 40 becomes large. In order to restrain the frame 40 from being deformed at a time of cutting work, the inner-circumference shape of the cylinder portion 41 is finished through cutting machining while receiving the portion that is close to the root portion, which is the inclination starting point of the fastening flange 42, and is the bending starting point at a time when the inclination of the fastening flange 42 is corrected so as to be horizontal by bolt fastening; thus, deformation of the frame 40 fixed to the supporting member 50 can be restrained. Therefore, the reliability of the strength of the frame 40 can be raised.

The manufacturing method for the electric rotating machine according to Embodiment 2 includes a first process in which the water jacket 70 is fitted on the frame 40, a second process in which the frame 40 and the water jacket 70 are welded to each other for sealing at the anti-fastening-flange side of the cylinder portion 41 of the frame 40, and a third process in which the frame 40 and the water jacket 70 are welded to each other for sealing at the fastening flange side of the cylinder portion 41 of the frame 40; the second process is performed before the third process is performed. In addition, the second process in this manufacturing method includes the second process and the third process in the foregoing manufacturing method.

It is allowed that the material of the frame 40 is ferrous or aluminum-based; however, it is desirable that because the stator core 31 is made of a ferrous material, a ferrous material is s n adopted for the frame 40. Making the material for the frame 40 the same as that for the stator core 31 can cancel the defect due to increase/decrease in the frame 40's holding power for the stator core 31, caused by the difference between the respective linear-expansion coefficients of the both materials.

In contrast, when an aluminum-based material is adopted for the frame 40, it is made possible that taking advantage of the linear-expansion-coefficient difference between the stator core 31 and the frame 40, there is selected a method in which the stator core 31 and the frame 40 are assembled with each other through shrink-fitting.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF REFERENCE NUMERALS

100: electric rotating machine
10: rotor
20: rotor shaft
30: stator
31: stator core
32: stator coil
40: frame
41: cylinder portion
42: fastening flange
421: bolt hole
422: root portion
50: supporting member
52: boss
61: bolt
70: water jacket
71: cooling passage

1.-13. (canceled)

14. A rotating electric machine comprising:
a stator core formed annularly;
a cylindrical tubular frame whose inner circumferential surface is fitted on the stator core and that holds the stator core;
a rotor that is disposed in an inner space of the stator core and whose outer circumferential surface faces an inner circumferential surface of the stator core through an air gap; and
a rotor shaft that is fixed to the rotor, and pivotably supported,
wherein the frame has a cylinder portion that fits the stator core into the inner circumferential surface, and a fastening flange that is provided at an axis-direction end portion of the cylinder portion, protrudes from the axis-direction end portion toward the radially outside of the cylinder portion, and is fastened to a supporting member that supports the electric rotating machine, and
wherein the fastening flange is formed in such a way as to incline toward a direction departing from the outer circumferential surface of the cylinder portion with respect to the radial direction of the cylinder portion, and it is configured in such a way that in a state where the fastening flange is fastened to the supporting member, compression-direction stress is generated on a root portion, at the outer circumferential surface side of the cylinder portion, of the fastening flange.

15. The rotating electric machine according to claim 14, further comprising a water jacket that is fitted on the outer circumferential surface of the cylinder portion of the frame so as to form a cooling passage therein, wherein the water jacket is welded to the frame so that the cooling passage is sealed.

16. The rotating electric machine according to claim 15, wherein an inclination angle of the fastening flange is set to be larger than an angle that decreases due to deformation of the frame caused by the fitting and the welding of the water jacket.

17. The electric rotating machine according to claim 15, wherein a plate-thickness dimension of the water jacket is set to be smaller than that of the frame.

18. The electric rotating machine according to claim 16, wherein a plate-thickness dimension of the water jacket is set to be smaller than that of the frame.

19. The electric rotating machine according to claim 15, wherein letting D [mm], δ [mm], and α denote an outer diameter of the frame, a fastening interference of the fitting, and a coefficient, respectively, after the water jacket has been fitted on an outer circumference portion of the frame, the D and the & are set in such a way that the relationship [α×8=D] is established in a range of a from “633.3” to “640”.

20. The electric rotating machine according to claim 16, wherein letting D [mm], δ [mm], and α denote an outer diameter of the frame, a fastening interference of the fitting, and a coefficient, respectively, after the water jacket has been fitted on an outer circumference portion of the frame, the D and the δ are set in such a way that the relationship [α×8=D] is established in a range of a from “633.3” to “640”.

21. The electric rotating machine according to claim 14, wherein the fastening flange has a bolt hole and is configured in such a way as to be fastened to the supporting member by a bolt to be inserted into the bolt hole.

22. The electric rotating machine according to claim 15, wherein the fastening flange has a bolt hole and is configured in such a way as to be fastened to the supporting member by a bolt to be inserted into the bolt hole.

23. The rotating electric machine according to claim 21, wherein letting X denotes a virtual straight line connecting the center of the frame with the center of the bolt hole and letting Y denotes the intersection point between the X and an outer-circumference edge of the fastening flange, the fastening flange has at least one flange-outer-circumferential-edge portion that is connected with a flange-outer-circumferential-arc portion that passes through the Y and whose center is the bolt hole or a flange-circumferential-straight-line portion, at an angle the same as or larger than 45[°] with respect to the X.

24. The rotating electric machine according to claim 22, wherein letting X denotes a virtual straight line connecting the center of the frame with the center of the bolt hole and letting Y denotes the intersection point between the X and an outer-circumference edge of the fastening flange, the fastening flange has at least one flange-outer-circumferential-edge portion that is connected with a flange-outer-circumferential-arc portion that passes through the Y and whose center is the bolt hole or a flange-circumferential-straight-line portion, at an angle the same as or larger than 45[°] with respect to the X.

25. The electric rotating machine according to claim 21, wherein the fastening flange has two or more flange pars, each of which has the bolt hole, and is configured in such a way as to be fastened to the supporting member by bolts to be inserted into respective bolt holes in the two or more flange pars, and wherein respective inclination angles of the two or more flange parts are individually set.

26. The electric rotating machine according to claim 23, wherein the fastening flange has two or more flange pars, each of which has the bolt hole, and is configured in such a way as to be fastened to the supporting member by bolts to be inserted into respective bolt holes in the two or more flange pars, and wherein respective inclination angles of the two or more flange parts are individually set.

27. The electric rotating machine according to claim 14, wherein the inclination angle of the fastening flange is the same as or smaller than 1[°] with respect to the radial direction.

28. The electric rotating machine according to claim 15, wherein the inclination angle of the fastening flange is the same as or smaller than 1[°] with respect to the radial direction.

29. A manufacturing method for the electric rotating machine according to claim 14,
wherein the inner circumferential surface of the frame is formed through cutting machining, and
wherein a machining-receiving surface at a time of the cutting machining is a portion, of the fastening flange, that is located more inside in the radial direction than the circumference of a pitch circle that passes through a radial-direction most-inner-circumferential point of a boss that is provided on the supporting member and receives the fastening flange.

30. A manufacturing method for the electric rotating machine according to claim 15,
wherein the inner circumferential surface of the frame is formed through cutting machining, and
wherein a machining-receiving surface at a time of the cutting machining is a portion, of the fastening flange, that is located more inside in the radial direction than the circumference of a pitch circle that passes through a radial-direction most-inner-circumferential point of a boss that is provided on the supporting member and receives the fastening flange.

31. A manufacturing method for the electric rotating machine according to claim 15,
wherein the outer circumferential surface of the cylinder portion of the frame that is fitted into the water jacket is formed through press working, and
wherein the inner circumferential surface of the cylinder portion of the frame that is fitted on the stator core is formed through cutting machining.

32. A manufacturing method for the electric rotating machine according to claim 15, the manufacturing method comprising:
a first process in which the water jacket is fitted on the frame;
a second process in which the frame and the water jacket are welded to each other for sealing at an anti-fastening-flange side of the cylinder portion of the frame; and
a third process in which the frame and the water jacket are welded to each other for sealing at the fastening flange side of the cylinder portion of the frame,
wherein the second process is performed before the third process is performed.

33. A manufacturing method for the electric rotating machine according to claim 15, the manufacturing method comprising:
a first process in which the water jacket is fitted on the frame;
a second process in which the frame and the water jacket are welded to each other for sealing;
a third process in which cutting machining is applied to the inner circumferential surface of the cylinder portion of the frame; and
a fourth process in which the stator core is fitted on the inner circumferential surface of the cylinder portion of the frame,
wherein the first process, the second process, the third process, and the fourth process are performed in that order.
